(19) United States
(12) Patent Application Publication
(10) Pub. No.: US 2018/0101062 A1
(43) Pub. Date: Apr. 12, 2018

(54) Display Device, Backlight Unit And Installment Framework Herein

(71) Applicant: Shenzhen China Star Optoelectronics Technology Co., Ltd., Shenzhen, Guangdong (CN)

(72) Inventor: Yongyuan QIU, Shenzhen, Guangdong (CN)

(73) Assignee: Shenzhen China Star Optoelectronics Technology Co., Ltd., Shenzhen, Guangdong (CN)

(21) Appl. No.: 15/104,535

(22) PCT Filed: May 24, 2016
(86) PCT No.: PCT/CN2016/083088

§ 371 Date: Jun. 15, 2016

(30) Foreign Application Priority Data
May 6, 2016 (CN) 201610298958.2

(51) Int. Cl. G02F 1/1335

(52) U.S. Cl. CPC G02F 1/133603; G02F 2001/133607; G02F 1/133608; G02F 1/133606

(57) ABSTRACT

The disclosure provides a display device, a backlight unit and an installment framework hereof, including a light guide plate, a light bar and an installment framework, wherein, the light bar is disposed beside the light guide plate; an installment framework is used to assemble the light bar via side inserting and used to clamp the sides of the light guide plate, an isolator is disposed upon the installment framework, wherein, the isolator is used in achieving isolating between the light guide plate and the light bar when light is permitted to pass through. Structures of the display device, backlight unit and installment framework provided in the present disclosure is easy to understand and catch and reliable; furthermore, with disposing an isolator, the light guide plate and the light bar can be isolated well to insure the light bar of un-easy to be damaged and easy to be installed and changed.

### FIELD OF THE INVENTION

The disclosure is related to display technical field, in particular to a display device, a backlight unit and an installment framework herein.

### BACKGROUND

A liquid crystal display, being a communication interface between human beings and information, is the mainstream in displaying method nowadays. With superior characteristics of high space utilization, low energy consumption, radiation free and low electromagnetic interference (EMI), it is broadly utilized in information communication tools, ex: televisions, cell phones, tablet and etc.

With further increasing in application field of the liquid crystal display, maintaining demands of displays keeps increasing as well.

One reason effects usage period, on the other word, one problem of out of work in displays usually occurs in light sources, which is light bars.

However, in present technology, installment of light bars of backlight units is usually too complicated to replace a new light bar to solve the problem.

### SUMMARY OF THE INVENTION

The disclosure provides a display device, a backlight unit and an installment framework hereof to solve the technical problem of un-easy change in light bars of the backlight unit in the present technology.

In order to solve the aforementioned technical problem, one technical solution adopted in the disclosure is: a display device is provided, the display device comprises a display panel and a backlight unit, and the backlight unite comprises:

a light guide plate;
a light bar disposed beside the light guide plate;
an installment framework used to install the light bar via side inserting and used to clamp the sides of the light guide plate, an isolator disposed upon the installment framework, wherein, the isolator is used in achieving isolating between the light guide plate and the light bar when light is permitted to pass through.

In order to solve the aforementioned technical problem, another technical solution adopted in the present disclosure is: providing another backlight unit, comprising:

a light guide plate;
a light bar disposed beside the light guide plate;
an installment framework used to install the light bar via side inserting and used to clamp the sides of the light guide plate, an isolator disposed upon the installment framework, wherein, the isolator is used in achieving isolating between the light guide plate and the light bar when light is permitted to pass through.

A preferred embodiment according to the present disclosure, the installment framework comprises:

an up framework plate;
a down framework plate disposed spaced apart parallelly with the up framework plate;
an intermediate support connecting with both the up framework plate and the down framework plate in perpendicular;
wherein, the isolator is extended from both the up framework plate and the down framework plate, a light bar mounting slot is formed by the isolator, the up framework plate, the intermediate support and the down framework plate, and a light guide plate clamping slot is formed by the isolator, the up framework plate and the down framework plate.

According to a preferred embodiment of the present disclosure, the light bar comprises a circuit board and LED lights disposed on the circuit board, a width of the circuit board is larger than a width of the LED lights on the circuit board, the circuit board is disposed into the light bar mounting slot, and the LED lights are protruded from the isolator.

According to a preferred embodiment of the present disclosure, he light bar comprises a circuit board and LED lights disposed on the circuit board, a width of the circuit board is same as a width of the LED lights on the circuit board, and both the circuit board and the LED lights on the circuit board are disposed inside the light bar mounting slot together.

According to a preferred embodiment of the present disclosure, a post is protruded from the top of the down framework plate, both a counterbore and a first screw connected to the post by passing through the counterbore are disposed on the up framework plate, a slot is disposed at a side of the light guide plate, and the light guide plate is further stopped by the post and the first screw when the light guide plate is inserting into the light guide plate clamping slot.

According to a preferred embodiment of the present disclosure, a positioning post passing through the down framework plate is disposed on the down framework plate, both a counterbore and a first screw connected to the positioning post by passing through the counterbore are disposed on the up framework plate, a slot is disposed at a side of the light guide plate, and the light guide plate is further stopped by the positioning post and the first screw when the light guide plate is inserting into the light guide plate clamping slot.

According to a preferred embodiment of the present disclosure, the backlight unit further comprises:

a backplate used to be fastening with the down framework plate by a second screw;
a reflective film disposed between the back side of the light guide plate and the backplate;
an optical film disposed on the top surface of the light guide plate;
a front frame formed in L-shaped, wherein, a side of the front frame used to be fastening with the intermediate support by a third screw;
wherein, a spacer tab is further extended from the top end of the up framework plate, a side of the optical film is covered by the spacer tab used to isolate the optical film and the display panel, and the display panel is covered by the other side of the front frame.

In order to solve the aforementioned technical problem, a technical solution adopted in the present disclosure is: an installment framework is provided, the installment framework is used to install a light bar via side inserting and used to clamp sides of the light guide plate, an isolator disposed upon the installment framework, and the isolator is used to achieve isolating between the light guide plate and the light bar when light can pass through.

Beneficial effects in present disclosure are: to distinguish situations from the present technology, structures of the display device, backlight unit and installment framework provided in the present disclosure is easy to understand and catch and reliable; furthermore, with disposing an isolator, the light guide plate and the light bar can be isolated well to insure the light bar of un-easy to be damaged and easy to be installed and changed.

### BRIEF DESCRIPTION OF THE DRAWINGS

In order to illustrate the technical solutions in the embodiments of the present disclosure more clearly, in the following, a brief introduction will be given to the accompanying drawings required for describing the embodiments of the present disclosure. Obviously, the accompanying drawings described as below are only for illustrating some of the embodiments of the present disclosure, and those skilled in the art can obtain other accompanying drawings from the drawings described without paying any inventive labor; wherein,

FIG. 1 is a section structural schematic diagram of a backlight unit according to a preferred embodiment of the present disclosure;

FIG. 2 is a section structural schematic diagram of a backlight unit according to another preferred embodiment of the present disclosure;

FIG. 3a is a structural schematic diagram of an installment framework according to a preferred embodiment of the present disclosure;

FIG. 3b is a structural schematic diagram of an installment framework according to another preferred embodiment of the present disclosure;

FIG. 3c is a structural schematic diagram of an installment framework according to another preferred embodiment of the present disclosure;

FIG. 3d is a structural schematic diagram of an installment framework according to another preferred embodiment of the present disclosure;

FIG. 4a is a top view of a light guide plate of a backlight unit according to a preferred embodiment of the present disclosure;

FIG. 4b is a top view of a light guide plate of a backlight unit according to another preferred embodiment of the present disclosure; and

FIG. 5 is a simplified structural diagram of a display device according to a preferred embodiment of the present disclosure.

### DETAILED DESCRIPTION

The technical solutions employed in the embodiments of the present disclosure are hereunder described to a great length with reference to the aforesaid figures. Apparently, there embodiments are not exhaustive. Any other embodiments, which persons skilled in the art obtain based on the embodiments set forth in the present disclosure without exercising inventive skills should also be construed to fall into the scope of the present disclosure.

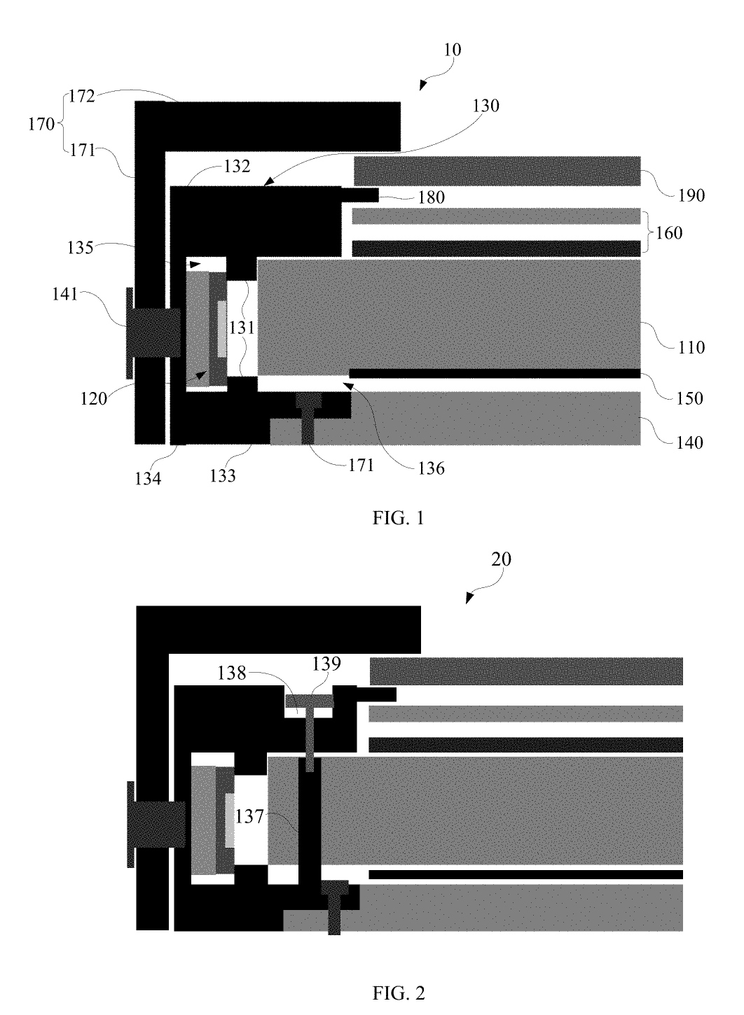

Please refer to FIG. 1 and FIG. 2 together, wherein, FIG. 1 is a section structural schematic diagram of a backlight unit according to a preferred embodiment of the present disclosure; and FIG. 2 is a section structural schematic diagram of a backlight unit according to another preferred embodiment of the present disclosure.

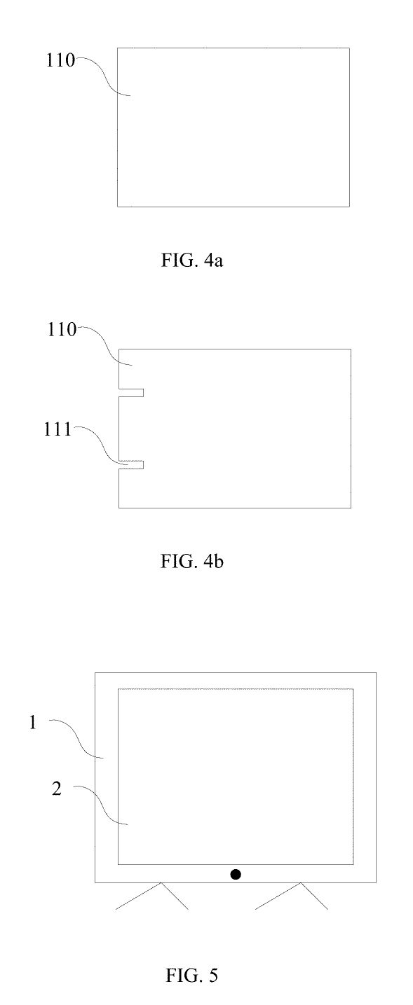

The backlight unit 10 is applicable in small size liquid crystal displays, and a light guide plate 110 hereof is shown as FIG. 4a: no specific fixing structure for stopping is needed at sides hereof.

The backlight unit 20 as shown in FIG. 2 is applicable in large size liquid crystal display, a light guide plate 110 is shown as FIG. 4b: a specific slot 111 is used for fixing structure for stopping at a side hereof.

As shown in FIG. 1, a backlight unit 10 is provided in the present disclosure, the backlight unit 10 comprises a light guide plate 110, a light bar 120, an installment framework 120, a backplate 140, a reflective film 150, an optical film 160 and a front frame 170, and the backlight unit 10 is used for providing back light to a display panel 190.

Specifically, the light bar 120 is disposed beside the light guide plate 110; an installment framework 130 used to install the light bar 120 via side inserting and used to clamp the sides of the light guide plate 110, an isolator 131 disposed upon the installment framework 130, wherein, the isolator 131 is used in achieving isolating between the light guide plate 110 and the light bar 120 when light is permitted to pass through to prevent the light guide plate 110 from impacting the light bar 120 and then damaging the light bar 120.

Wherein, the installment framework 130 comprises: an up framework plate 132, a down framework plate 133 and an intermediate support 134. The down framework plate 133 is disposed spaced apart parallelly with the up framework plate 132; the intermediate support 134 connecting with both the up framework plate 132 and the down framework plate 133 in perpendicular; wherein, the isolator 131 is extended from both the up framework plate 132 and the down framework plate 133, a light bar mounting slot 135 is formed by the isolator 131, the up framework plate 132, the intermediate support 134 and the down framework plate 135 to form a n independent space for installing the light bar 120; the independent space can provide convenience to disassemble without affecting other structures, and plastic sealing pieces can be disposed at two ends of the light bar mounting slot 135 to further protect the light bar 120. A light guide plate clamping slot 136 is formed by the isolator 131, the up framework plate 132 and the down framework plate 133, and the isolator 131 provides a better isolated protective function for the light guide plate 110. In the preferred embodiment, a width of the isolator 131 is 0.4˜2.5 mm.

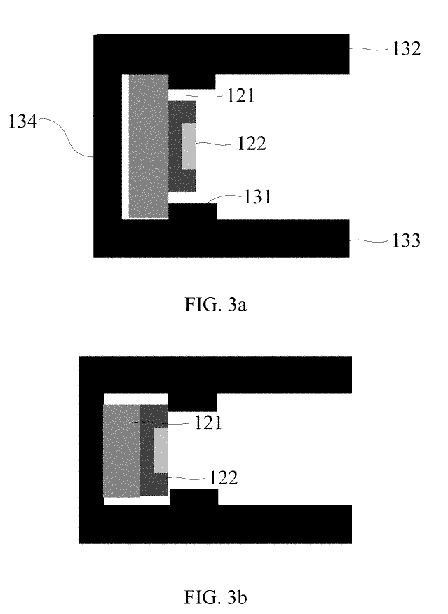

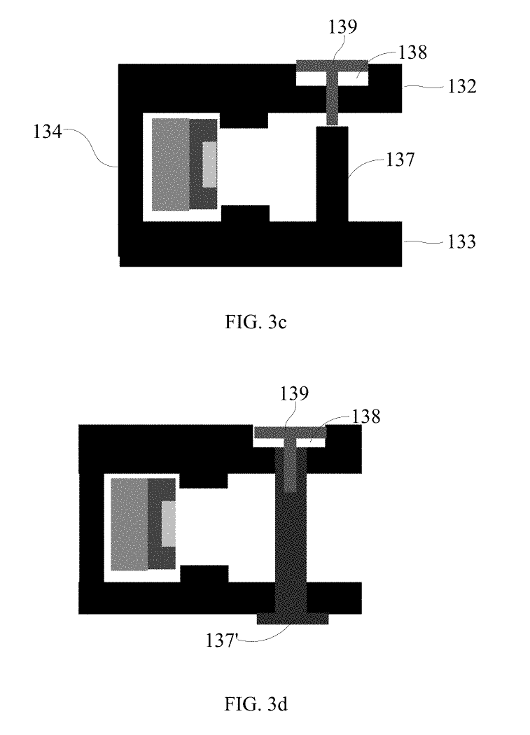

Please refer to FIG. 3a together, in a preferred embodiment of the present disclosure, the light bar 120 comprises a circuit board 121 and LED lights 122 disposed on the circuit board; when satisfying the condition that a width of the circuit board 121 with electrical traces is larger than a width of the LED lights 122 on the circuit board 121, the circuit board 121 is disposed into the light bar mounting slot 135, and the LED lights 122 are protruded from the isolator 131 to decrease the light coupling distance and then further to increase light efficiency.

Please refer to FIG. 3b together, in another preferred embodiment of the present disclosure, the light bar 120 comprises a circuit board 121 and LED lights 122 disposed on the circuit board 121, and a width of the circuit board is same as or is similar to a width of the LED lights on the circuit board. The width of the circuit board 121 is needed to be enough for the smallest electrical traces, and both the circuit board and the LED lights on the circuit board are disposed inside the light bar mounting slot together. This structure is easy to be assembled.

Please refer to FIG. 2, FIG. 3c and FIG. 4b, in a preferred embodiment of the present disclosure, a post 137 is protruded from the top of the down framework plate 133, both a counterbore 138 and a first screw 139 connected to the post 137 by passing through the counterbore 138 are disposed on the up framework plate 132, a slot 111 is disposed at a side of the light guide plate 110 corresponding to the post 137, the number of the post 137 and the slot 111 is not limited hereto, and the light guide plate 110 is further stopped by the post 137 and the first screw 139 when the light guide plate 110 is inserting into the light guide plate clamping slot 136; the post 137 and the first screw 139 can further assist to strengthening the isolating efficiency of the isolator 131 to prevent the light guide plate 110 from over moving.

Please refer to FIG. 2, FIG. 3d and FIG. 4b together, in another preferred embodiment, a positioning post 137′ passing through the down framework plate 133 is disposed on the down framework plate 133, both a counterbore 133 and a first screw 139 connected to the positioning post 137′ by passing through the counterbore 133 are disposed on the up framework plate 132, a slot 111 is disposed at a side of the light guide plate 110 corresponding to the positioning post 137′, and the number of both the positioning post 137′ and the slot 111 are not limited hereto; the light guide plate 110 is further stopped by the positioning post 137′ and the first screw 139 when the light guide plate 110 is inserting into the light guide plate clamping slot 136 in order to further assist isolating efficiency of the isolator 131 and to prevent the light guide plate 110 from over moving.

In the embodiment shown in FIG. 3c and FIG. 3d, the design of the post 137 and the positioning post 137′ is mainly applicable in the design of extra-large-size (ex: lager than 55 inches); in this condition, demands of the weight and the expanding spaces is more important, thus increasing the post 137 and the positioning post 137′ can ensure strength of coupling light structure.

Please continue refer to FIG. 1 and FIG. 2, the backplate 140 is used to be fastening with the down framework plate 133 by a second screw 171, and the step adjusting structure is preferred to be applied as shown in figures; a reflective film 150 is disposed between the back side of the light guide plate 110 and the backplate 140; an optical film 160 is disposed on the top surface of the light guide plate 110; a front frame 170 is formed in L-shaped, wherein, a side of the front frame 170 is used to be fastening with the intermediate support 134 by a third screw 141. Of course, fixing methods between the backplate 140 and the down framework plate 133 or between the intermediate support 134 can be performed by buckles or adhesive tapes.

In embodiments of the present disclosure, a spacer tab 180 is further extended from the top end of the up framework plate 132, a side of the optical film 160 is covered by the spacer tab 180 used to isolate the optical film 160 and the display panel 190, and the display panel 190 is covered by the other side 172 of the front frame 170.

Please refer to FIG. 1 to FIG. 4b together, the present disclosure further provides an installment framework 130. The installment framework 130 is used to assemble the light bar 120 via side inserting and used to clamp the sides of the light guide plate 110, an isolator 131 is disposed upon the installment framework 130, wherein, the isolator 131 is used in achieving isolating between the light guide plate 110 and the light bar 120 when light can pass through.

Wherein, the installment framework 130 comprises an up framework plate 132, a down framework plate 133 and an intermediate support 134. The down framework plate 133 is disposed spaced apart parallelly with the up framework plate 132; the intermediate support 134 is connecting both the up framework plate 132 and the down framework plate 133 in perpendicular; wherein, the isolator 131 is extended from both the up framework plate 132 and the down framework plate 133, a light bar mounting slot 135 is formed by the isolator 131, the up framework plate 132, the intermediate support 134 and the down framework plate 133, and a light guide plate clamping slot 136 is formed by the isolator 131, the up framework plate 132 and the down framework plate 133.

An embodiment as shown in FIG. 3c, a post 137 is protruded from the top of the down framework plate 137, both a counterbore 138 and a first screw 139 which is connected to the post 137 by passing through the counterbore 138 are disposed on the up framework plate 132; as shown in FIG. 4b, corresponding to the post 137, a slot 111 is disposed at a side of the light guide plate 110, and the light guide plate 110 is further stopped by the post 137 and the first screw 139 when the light guide plate 110 is inserting into the light guide plate clamping slot 136.

Another embodiment as shown in FIG. 3d, a positioning post 137′ passing through the down framework plate 133 is disposed on the down framework plate 133, both a counterbore 138 and a first screw 139 connected to the positioning post 137′ by passing through the counterbore 138 are disposed on the up framework plate 132; as shown in FIG. 4b, corresponding to the positioning post 137′, a slot 111 is disposed at a side of the light guide plate 110, and the light guide plate 110 is further stopped by the positioning post 137′ and the first screw 139 when the light guide plate 110 is inserting into the light guide plate clamping slot 136.

Please refer to FIG. 5 together; FIG. 5 is a simplified structural diagram of a display device according to a preferred embodiment of the present disclosure.

The present disclosure further provides a display device, and the display device comprises a front frame 1, a display panel 2 and the aforementioned backlight unit.

From the above, people skilled in the art are easy to understand that structures of the display device, the backlight unit 10 and the installment framework 130 are easy and reliable, and because of disposition of isolator 131, the light guide plate 110 and the light bar 120 can be isolated well to prevent the light bar 120 from easily damaged and further facilitate the light bar 120 to be assembled and replaced.

The above description is only for embodiments of the present disclosure, but not intended to limit disclosure scope for the present disclosure. Any equivalent process flow modifications that are made according to the specification and the attached drawings of the present disclosure, or any direct or indirect application of the present disclosure in other related technical fields shall all be covered within the protection scope of the present disclosure.

1, A display device comprising a display panel and a backlight unit, wherein, the backlight unit comprises:
a light guide plate;
a light bar disposed beside the light guide plate;
an installment framework used to install the light bar via side inserting and used to clamp the sides of the light guide plate, an isolator disposed upon the installment framework, wherein, the isolator is used in achieving isolating between the light guide plate and the light bar when light is permitted to pass through.

2, The display device according to claim 1, wherein, the installment framework comprises:
an up framework plate;
a down framework plate disposed spaced apart parallelly with the up framework plate;
an intermediate support connecting with both the up framework plate and the down framework plate in perpendicular;
wherein, the isolator is extended from both the up framework plate and the down framework plate, a light bar mounting slot is formed by the isolator, the up framework plate, the intermediate support and the down framework plate, and a light guide plate clamping slot is formed by the isolator, the up framework plate and the down framework plate.

3, The display device according to claim 2, wherein, the light bar comprises a circuit board and LED lights disposed on the circuit board, a width of the circuit board is larger than a width of the LED lights on the circuit board, the circuit board is disposed into the light bar mounting slot, and the LED lights are protruded from the isolator.

4, The display device according to claim 2, wherein, the light bar comprises a circuit board and LED lights disposed on the circuit board, a width of the circuit board is same as a width of the LED lights on the circuit board, and both the circuit board and the LED lights on the circuit board are disposed inside the light bar mounting slot together.

5, The display device according to claim 2, wherein, a post is protruded from the top of the down framework plate, both a counterbore and a first screw connected to the post by passing through the counterbore are disposed on the up framework plate, a slot is disposed at a side of the light guide plate, and the light guide plate is further stopped by the post and the first screw when the light guide plate is inserting into the light guide plate clamping slot.

6, The display device according to claim 2, wherein, a positioning post passing through the down framework plate is disposed on the down framework plate, both a counterbore and a first screw connected to the positioning post by passing through the counterbore are disposed on the up framework plate, a slot is disposed at a side of the light guide plate, and the light guide plate is further stopped by the positioning post and the first screw when the light guide plate is inserting into the light guide plate clamping slot.

7, The display device according to claim 2, wherein, the backlight unit further comprises:
a backplate used to be fastening with the down framework plate by a second screw;
a reflective film disposed between the back side of the light guide plate and the backplate;
an optical film disposed on the top surface of the light guide plate;
a front frame formed in L-shaped, wherein, a side of the front frame used to be fastening with the intermediate support by a third screw;
wherein, a spacer tab is further extended from the top end of the up framework plate, a side of the optical film is covered by the spacer tab used to isolate the optical film and the display panel, and the display panel is covered by the other side of the front frame.

8, A backlight unit, wherein, comprises:
a light guide plate;
a light bar, disposed at a side of the light guide plate;
an installment framework, used to install the light bar via side inserting and used to clamp the sides of the light guide plate, an isolator disposed upon the installment framework, wherein, the isolator is used in achieving isolating between the light guide plate and the light bar when light can pass through.

9, The backlight unit according to claim 8, wherein, the installment framework comprises:
an up framework plate;
a down framework plate, disposed spaced apart parallelly with the up framework plate;
an intermediate support, connecting both the up framework plate and the down framework plate in perpendicular;
wherein, the isolator is extended from both the up framework plate and the down framework plate, a light bar mounting slot is formed by the isolator, the up framework plate, the intermediate support and the down framework plate, and a light guide plate clamping slot is formed by the isolator, the up framework plate and the down framework plate.

10, The backlight unit according to claim 9, wherein, the light bar comprises a circuit board and LED lights disposed on the circuit board, a width of the circuit board is larger than a width of the LED lights on the circuit board, the circuit board is disposed into the light bar mounting slot, and the LED lights are protruded from the isolator.

11, The backlight unit according to claim 9, wherein, the light bar comprises a circuit board and LED lights disposed on the circuit board, a width of the circuit board is same as a width of the LED lights on the circuit board, and both the circuit board and the LED lights on the circuit board are disposed inside the light bar mounting slot together.

12, The backlight unit according to claim 9, wherein, a post is protruded from the top of the down framework plate, both a counterbore and a first screw connected to the post by passing through the counterbore are disposed on the up framework plate, a slot is disposed at a side of the light guide plate, and the light guide plate is further stopped by the post and the first screw when the light guide plate is inserting into the light guide plate clamping slot.

13, The backlight unit according to claim 9, wherein, a positioning post passing through the down framework plate is disposed on the down framework plate, both a counterbore and a first screw connected to the positioning post by passing through the counterbore are disposed on the up framework plate, a slot is disposed at a side of the light guide plate, and the light guide plate is further stopped by the positioning post and the first screw when the light guide plate is inserting into the light guide plate clamping slot.

14, The backlight unit according to claim 9, wherein, the backlight unit further comprises:
a backplate used to be fastening with the down framework plate by a second screw;
a reflective film disposed between the back side of the light guide plate and the backplate;
an optical film disposed on the top surface of the light guide plate;
a front frame formed in L-shaped, wherein, a side of the front frame used to be fastening with the intermediate support by a third screw;
wherein, a spacer tab is further extended from the top end of the up framework plate, a side of the optical film is covered by the spacer tab used to isolate the optical film and the display panel, and the display panel is covered by the other side of the front frame.

15, An installment framework, wherein, the installment framework is used to install a light bar via side inserting and used to clamp sides of the light guide plate, an isolator disposed upon the installment framework, and the isolator is used to achieve isolating between the light guide plate and the light bar when light can pass through.

16, The installment framework according to claim 15, wherein, the installment framework comprises:
an up framework plate;
a down framework plate, disposed spaced apart parallelly with the up framework plate;
an intermediate support, connecting both the up framework plate and the down framework plate in perpendicular;
wherein, the isolator is extended from both the up framework plate and the down framework plate, a light bar mounting slot is formed by the isolator, the up framework plate, the intermediate support and the down framework plate, and a light guide plate clamping slot is formed by the isolator, the up framework plate and the down framework plate.

17, The installment framework according to claim 15, wherein, a post is protruded from the top of the down framework plate, both a counterbore and a first screw connected to the post by passing through the counterbore are disposed on the up framework plate, a slot is disposed at a side of the light guide plate, and the light guide plate is further stopped by the post and the first screw when the light guide plate is inserting into the light guide plate clamping slot; or
a positioning post passing through the down framework plate is disposed on the down framework plate, both a counterbore and a first screw connected to the positioning post by passing through the counterbore are disposed on the up framework plate, a slot is disposed at a side of the light guide plate, and the light guide plate is further stopped by the positioning post and the first screw when the light guide plate is inserting into the light guide plate clamping slot.
